(19) United States
(12) Patent Application Publication
(10) Pub. No.: US 2008/0086676 A1
(43) Pub. Date: Apr. 10, 2008

(54) SEGREGATION OF REDUNDANT CONTROL BITS IN AN ECC PERMUTED, SYSTEMATIC MODULATION CODE

(76) Inventor: John P. Mead, Longmont, CO (US)

Correspondence Address: GARLICK HARRISON & MARKISON, P.O. BOX 160727, AUSTIN, TX, 78716-0727, US

(21) Appl. No.: 11/694,985

(22) Filed: Mar. 31, 2007

Related U.S. Application Data
(60) Provisional application No. 60/788,271, filed on Mar. 31, 2006.

(51) Int. Cl. G06F 11/10

(52) U.S. Cl. 714/758; 714/E11.053

(57) ABSTRACT

Redundant information may be stored separately and contiguously with encoded user data such that all redundant information is co-located. Boundaries may be defined as to how error correction coding is processed such that redundant information may be corrected independently from encoded user data. By providing this ability many controller related issues are addressed and the propagation of errors and the effects thereof may be reduced.

### CROSS REFERENCE TO RELATED APPLICATIONS

This application claims priority to and incorporates by reference in its entirety for all purposes U.S. Provisional Application No. 60/788,270 filed on 31 Mar. 2006 and entitled “SEGREGATION OF REDUNDANT CONTROL BITS IN AN ECC PERMUTED, SYSTEMATIC MODULATION CODE” to John Mead.

### TECHNICAL FIELD OF THE INVENTION

Embodiments of the present invention relate generally to memory storage devices; and, more particularly, embodiments of the present invention relate to error control within memory storage devices.

### BACKGROUND OF THE INVENTION

As is known, many varieties of memory storage devices (e.g. disk drives), such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

The structure and operation of hard disk drives is generally known. Hard disk drives include, generally, a case, a hard disk having magnetically alterable properties, and a read/write mechanism including Read/Write (RW) heads operable to write data to the hard disk by locally alerting the magnetic properties of the hard disk and to read data from the hard disk by reading local magnetic properties of the hard disk. The hard disk may include multiple platters, each platter being a planar disk.

All information stored on the hard disk is recorded in tracks, which are concentric circles organized on the surface of the platters. FIG. 1 depicts a pattern of radially-spaced concentric data tracks 12 within a disk 10. Data stored on the disks may be accessed by moving RW heads radially as driven by a head actuator to the radial location of the track containing the data. To efficiently and quickly access this data, fine control of RW hard positioning is required. The track-based organization of data on the hard disk(s) allows for easy access to any part of the disk, which is why hard disk drives are called “random access” storage devices.

Since each track typically holds many thousands of bytes of data, the tracks are further divided into smaller units called sectors. This reduces the amount of space wasted by small files. Each sector holds 512 bytes of user data, plus as many as a few dozen additional bytes used for internal drive control and for error detection and correction.

Within such hard disk drives (HDDs), error correction coding (ECC) is sometimes employed to ensure the ability to correct for errors of data that is written to and read from the storage media of a HDD. The ECC allows the ability to correct for those errors within the error correction capability of the code.

In disk drive controllers, disk drive modulation codes are often reverse-ordered (permuted) with the ECC system in order to eliminate the problem error propagation of large and efficient modulation code words, which could cause multiple ECC symbol corruption. Reversing the order of the modulation code encoder decoder (ENDEC) and the ECC system causes several issues that are difficult and costly to deal with in the hard disk drive controller. These disk drive controllers may be single-chip (SoC) or multi chip solutions. Reverse order ECC modulation may be performed to reduce error propagation. In multi chip solutions this may be achieved by moving

Additionally RLL (Run Length Limiting) mode of the ENDEC is limits the run length of ones, zeros, or the two Nyquist (repeating “01” or “10”) patterns in the signal transmitted by the read channel within longitudinal recordings. The RDS (Running Digital Sum) mode for perpendicular recording limits the DC content of the signal. An RDS code will also suffice as an RLL code since controlling the DC content of a signal will always limit the run length. However, due to the rate of the RDS code, there is an unnecessary penalty for using it with a longitudinal recording channel. Hence, a nearly unity rate RLL code is provided. When an RLL or RDS encode is performed chronologically following the ECC encoding, the RLL/RDS decoding must be performed prior to the ECC decoding. For a system that performs the named operations in this order, there will be some degradation in the effectiveness of the ECC system due to error propagation. For this reason, the RLL/RDS ENDEC is also reverse ordered with the ECC.

With modulation codes, such as RLL/RDS, the redundant bits are only used for decoding purposes. (i.e., the redundant bits do not have any component of the user data embedded within them.) However, encoding these redundant bits can result in decoding errors should an error be propagated within the encoding and decoding of these bits. Such an error may be propagated throughout the encoded data, corrupting the data beyond the capabilities of the ECC scheme.

### SUMMARY OF THE INVENTION

Embodiments of the present invention are directed to systems and methods that are further described in the following description and claims. Advantages and features of embodiments of the present invention may become apparent from the description, accompanying drawings and claims.

Further limitations and disadvantages of conventional and traditional error code correction (ECC) and modulation processes and related functionality will become apparent to one of ordinary skill in the art through comparison with the present invention described herein.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts a prior art pattern of radially-spaced concentric data tracks within the magnetic media of a disk;

FIG. 2 depicts a prior art four burst amplitude servo pattern used to determine RW head radial position;

FIG. 3A depicts the sensed amplitude signal of the prior art four bursts of FIG. 2 as a function of RW head radial position;

FIG. 3B depicts a prior art sensed servo signal as detected on an individual track;

FIG. 4 depicts a hard disk drive that includes control circuitry operable to determine RW head radial position in accordance with an embodiment of the present invention;

FIG. 5 depicts an RDL/RLL ENDEC used within embodiments of the present invention;

FIG. 6 depicts the integration of RDS1 and RDS 2 redundant information into disk data stream in accordance with embodiments of the present invention;

FIG. 7 provides a logic flow diagram describing a disk write operation in accordance with embodiments of the present invention;

FIG. 8 provides a logic flow diagram describing a disk read operation in accordance with embodiments of the present invention;

FIG. 9 depicts the integration of the RLL randomizer seed into the disk data stream in accordance with embodiments of the present invention;

FIG. 10 provides a logic flow diagram describing a disk write operation in accordance with embodiments of the present invention; and

FIG. 11 provides a logic flow diagram describing a disk read operation in accordance with embodiments of the present invention.

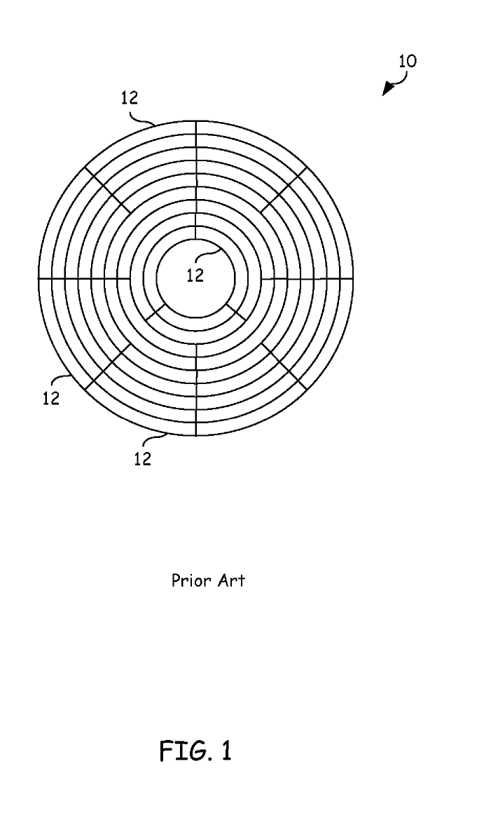

### DETAILED DESCRIPTION OF THE INVENTION

Embodiments of the present invention are illustrated in the FIGs., like numerals being used to refer to like and corresponding parts of the various drawings.

Embodiments of the present invention provide a system and method which may segregate redundant control bits. Segregation of redundant bits in accordance with embodiments of the present invention facilitates the storage and retrieval of user data. By integrating both error correction capabilities (ECC) and systematic coding within the disk controller, the potential to propagate errors of encoded data is significantly reduced. Unlike prior schemes which encoded modulation code control bits with the user data, embodiments of the present invention separate the encoded user data and the redundant control bits. In this way the redundant control bits can be recovered, (this may involve the application of an error control scheme) to ensure that the proper redundant control bits are recovered. Then these redundant control bits may be used to process the encoded user data and CRC or ECC bits. This segregation of the redundant control bits helps to ensure: that; (1) data is not lost when improper modulation coding bits are not recovered; or (2) the propagation of errors throughout the encoded user data.

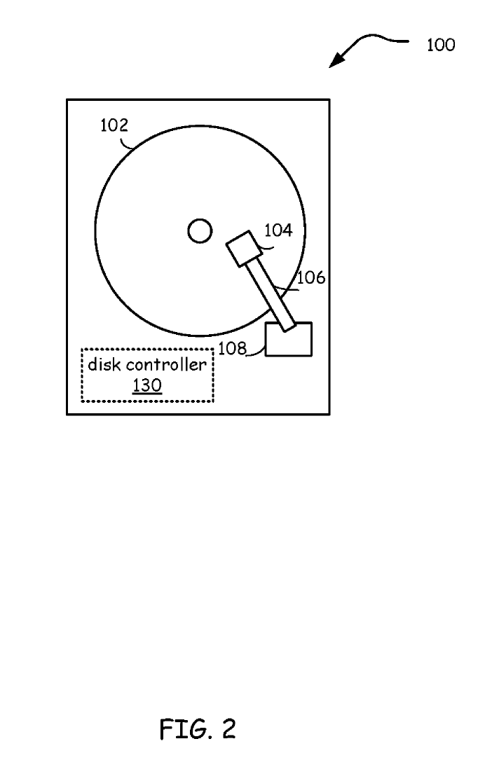

FIG. 2 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write heads 104 that are coupled to arm 106 that is moved by actuator 108 over the surface of the disk 102 either by translation, rotation or both. A disk controller 130 is included for controlling the read and write operations to and from the drive, for controlling the speed of the servo motor and the motion of actuator 108, and for providing an interface to and from the host device.

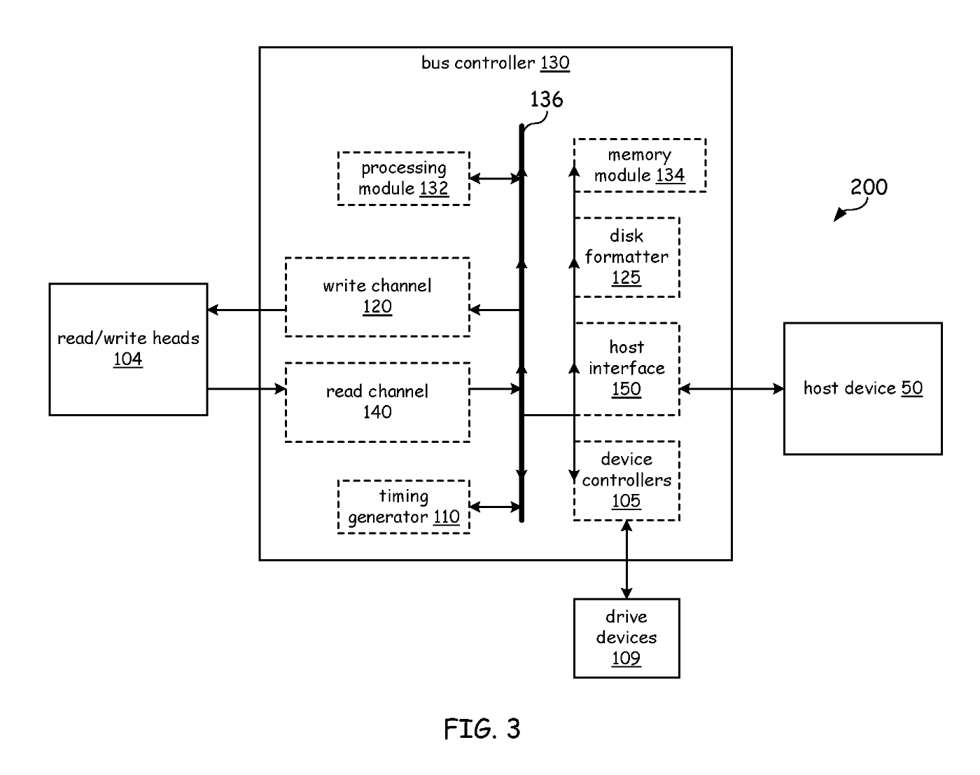

FIG. 3 illustrates an embodiment of a disk controller 130. Disk controller 130 includes a read channel 140 and write channel 120 for reading and writing data to and from disk 102 through read/write heads 104. Disk formatter 125 is included for controlling the formatting of disk drive unit 100, timing generator 110 provides clock signals and other timing signals, device controllers 105 control the operation of drive devices 109 such as actuator 108 and the servo motor, etc. Host interface 150 receives read and write commands from host device 50 and transmits data read from disk 102 along with other control information in accordance with a host interface protocol. In one possible embodiment, the host interface protocol can include, SCSI, SATA, enhanced integrated drive electronics (EIDE), or any number of other host interface protocols, either open or proprietary, that can be used for this purpose.

Disk controller 130 further includes a processing module 132 and memory module 134. Processing module 132 can be implemented using one or more microprocessors, microcontrollers, digital signal processors (DSPs), microcomputers, central processing units (CPUs), field programmable gate arrays (FPGAs), programmable logic devices (PLAs), state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing timing generator 110, processing module 132, memory module 134, write channel 120, read channel 140, disk formatter 125, and host interface 150 that are interconnected via bus 136. Each of these modules can be implemented in hardware, firmware, software or a combination thereof, in accordance with the broad scope of the present invention. While the particular bus architecture is shown in FIG. 2 with a single bus 136, alternative bus architectures that include additional data buses, further connectivity, such as direct connectivity between the various modules, are likewise possible to implement additional features and functions.

In one possible embodiment, one or more modules of disk controller 130 are implemented as part of a system on a chip (SOC) integrated circuit. In such a possible embodiment, this SOC integrated circuit includes a digital portion that can include additional modules such as protocol converters, linear block code encoding and decoding modules, etc., and an analog portion that includes device controllers 105 and optionally additional modules, such as a power supply, etc. In an alternative embodiment, the various functions and features of disk controller 130 are implemented in a plurality of integrated circuit devices that communicate and combine to perform the functionality of disk controller 130.

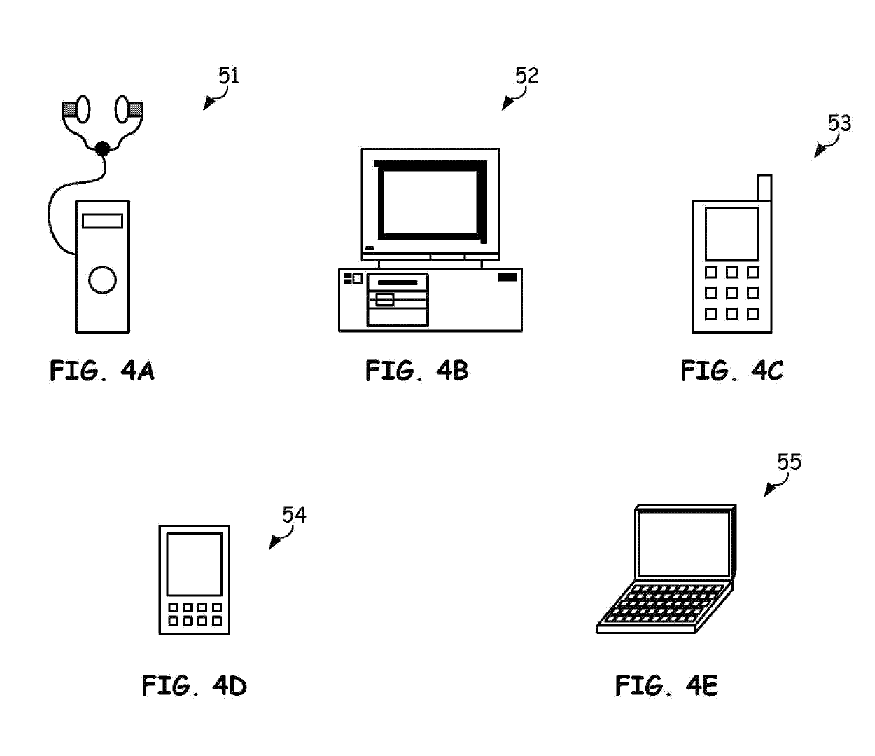

FIG. 4A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 4B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 4C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 4D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 4E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

When implementing ECCs within devices that include HDDs, many different types of processes may be performed during the encoding and decoding processing. Various types of ECCs can be employed including turbo coding, turbo trellis coded modulation (TTCM), parallel concatenated turbo code modulation (PC-TCM), Reed-Solomon (RS) coding, LDPC (Low Density Parity Check) coding, and/or other types of ECC. Additionally, Run length limiting (RLL) and Running digital sum (RDS) and may also be applied to control DC content of stored signals.

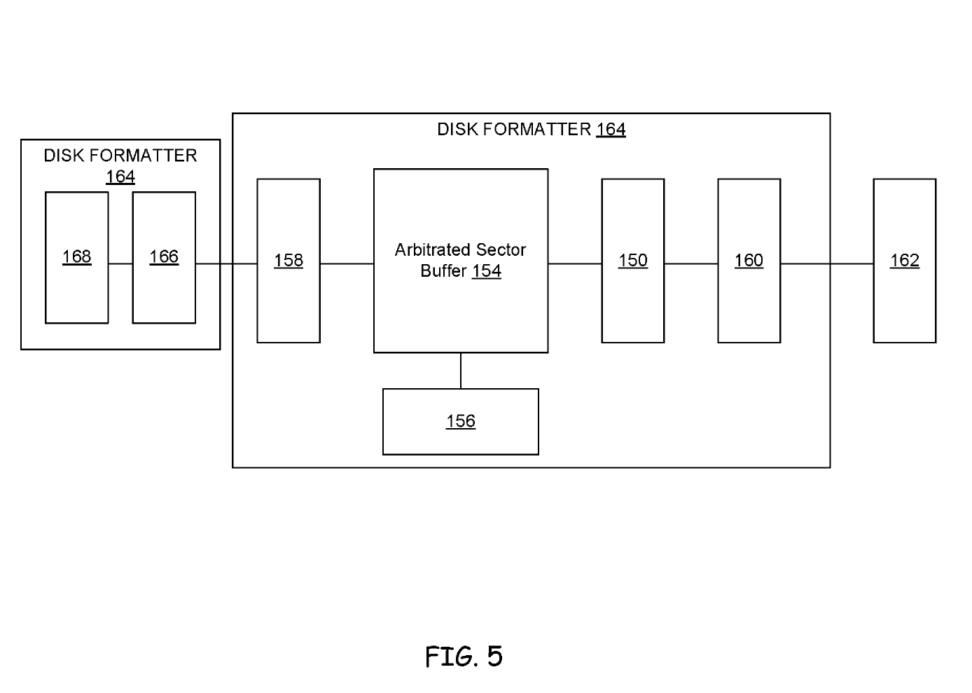

An RDS/RLL data encoder/decoder (ENDEC) modifies the user data to improve the properties of the data when processed using longitudinal recording channels. This allows the data, as read, to satisfy a pre-defined run-length constraint. For perpendicular recording channels, the RDS/RLL ENDEC will not have an excessive amount of DC content. FIG. 5 depicts an RDL/RLL used within embodiments of the present invention. This embodiment segregates data bits and redundant bits in order to facilitate the storage and retrieval of user data. This allows data symbols that fit within familiar boundaries to be generated only from either data bits or redundant information bits. User data may be used to directly generate data symbols from user data. Redundant information bits may be accumulated until enough bits are present to generate a redundant information data symbol. ECC may be applied to the user data and redundant information separately.

Integrating both error correction capabilities and systematic coding within the disk controller, allows the potential to propagate errors of encoded data to be significantly reduced. Unlike prior schemes which encoded modulation code control bits with the user data, embodiments of the present invention separate the encoded user data and the redundant information (redundant control bits). In this way the redundant bits can be recovered and may involve the application of an error control scheme to ensure that the proper redundant control bits are recovered. This processing scheme helps to ensure that data is not lost when improper modulation coding bits are not recovered or result in the propagation of errors throughout the encoded user data.

FIG. 5 provides a functional block diagram of the connections between RDL/RLL ENDEC 150 and surrounding functional blocks in accordance with embodiments of the present invention. The first series of functional blocks 152 is collectively known as the disk data path. These functional blocks include an arbitrated sector buffer (ASB) 154, on the fly error correction (OTFEC) module 156, FIFO buffer 158, 48/32 translator 160 and the previously mentioned RLL/RDS ENDEC 150. Disk data path 152 can be communicatively coupled to buffer manager 162 as well as disk formatter 164. Disk formatter may include a bit staging module 166 and a channel interface 168.

Traditionally ENDEC 150 has been located in the channel, this stems from prior configurations where the read channels were not integrated with the HDD control logic. These configurations may be a SoC or multi chip solution. RDS/RLL ENDEC 150 has previously been considered to be part of the channel technology, which was not integrated into the disk controller. However, one can now integrate the read channel and the disk drive controller into a SoC solution. Such integration now allows one to reverse the order of the ECC and ENDEC.

Redundant information can be broken apart from the user data. The segregated redundant information and user data may then be used to generate data symbols. These data symbols comprise user data symbols and redundant information symbols. These data symbols may then be modulated using a systematic code such as an RLL and RDS data translation to reduce the DC content of the encoded data symbols.

When redundant information is segregated from the user data and transferred separately, no translation is required in order to repack the data within familiar boundaries. The redundant information may be accumulated until enough information is present to fit within a predefined boundary. In a prior system where the RDS/RLL encoding/decoding is performed in parallel at higher frequencies, translation of large amounts of user data that exceeds familiar boundaries back to the data path width adds a substantial amount of SOC complexity and timing difficulty to ENDEC 150. First, such solutions require a more complicated elastic pipeline in order to generate and remove the extra words through the data path. Second, a fairly cumbersome circuit may be required to perform the translation. The wider the code word, the more cumbersome the translation and the more difficult it will be to meet the timing requirements.

A second advantage of systematic codes is the simplification that systematic codes provide in determining the locations of the redundant information. This allows an ECC scheme to correct the redundant information and encoded user data separately. This helps ensure that the decoding process is correctly performed. For example, this may be particularly useful within diagnostics applications where a user wants to determine bit-error rates (BER) of user data on the media. Another advantage relates to performing S/W ECC correction in the main buffer. If the redundant information is not segregated from the user data, the redundant information will be much more difficult to re-encode with the uncorrected redundant information, correct the encoded data and decode the data with the corrected redundant information. Segregating the redundant information greatly simplifies this process.

Since the ENDEC processes are tightly integrated with read channel processes an RLL/RDS ENDEC interface specification may be used to define an interface that provides a means for segregating the redundant information and defines a signaling and feedback mechanism to properly connect into the controllers data path.

When the RDS mode is enabled, the RDS encoder stores a predetermined number of bits (the length of an RDS code word) of user data in a pipelined register bank internal to ENDEC 150 prior to encoding. For example, the length of the code word was chosen in one embodiment to be evenly devisable by the 48-bit data path width. Based on the properties of the data, one of four possible encoding selections will be chosen such that the RDS is nearest to zero. This choice allows the DC content to be minimized. The choice of the encoding selection related to the new code word is stored as two bits of redundant information and is accumulated in a side register.

During the transfer of user data from the main buffer into ASB 152, a one-for-one shift of quad symbols is performed through RDS encoder 150 once its pipeline is filled. Meanwhile, each time 12-bits (a symbol) of redundant information is accumulated, a request is made to ASB to store a new redundant symbol at the next (segregated) redundant information location within ASB. The storage location for this redundant information within the ASB is defined by a pointer within ASB which is pre-loaded at the beginning of a host-side ASB transfer with a starting location defined by a previously stored value.

Since the starting location of the redundant information within the disk sector can be non-aligned on a quad-symbol boundary, the final (partial) quad symbol of RDS encoded user data must be properly combined with the initial redundant information symbol(s) such that they are preserved as initially written. This is solved within the ASB logic and is not required to be addressed by the RDS encoder.

A second RDS encoder (RDS2) and an RDS checking circuit may be provided in the Disk Formatter to ensure that the ECC parity bits and the segregated redundant information do not violate RDS constraints.

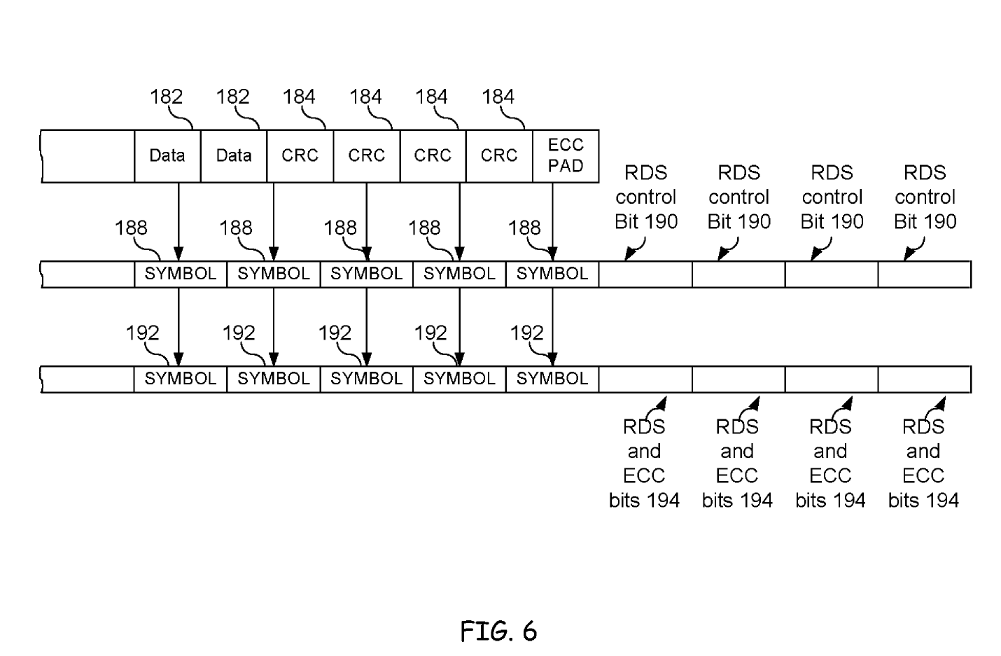

FIG. 6 depicts the integration of RDS1 and RDS 2 redundant information into disk data stream 180. As shown here, data bits 182 and redundant information bits such as CRC bits 184 are segregated and followed by ECC information 186. During a disk write operation having the RDS mode enabled, the stream (including both data and error correction information) is processed to reduce the DC content. This in turn facilitates the longitudinal storage and retrieval of the information from the magnetic media. This results in data symbols 188 that fit within familiar boundaries to be generated only from either data bits or redundant information bits. User data may be used to directly generate data symbols from user data. Redundant information bits may be accumulated until enough bits are present to generate a redundant information data symbol. ECC may be applied to the user data and redundant information separately. These data symbols may be modulated using a systematic code that specifies how the user data and error correction bits have been scrambled (modulated) in order to minimize DC content and facilitate storage to and retrieval from magnetic media. RDS control bits 190 describe this process. Prior to being written to disk, this information may be further analyzed to determine whether or not a further need exists to reduce the DC content of the RDS control bits by performing a second RDS encoding. In such a case the RDS and ECC bits 194 may be stored separately from symbols 192. This allows the RDS or modulation control bits 194 to be retrieved and processed separately so that errors associated with the decoding and encoding of these bits do not propagate through the reading and writing of data to and from the magnetic media.

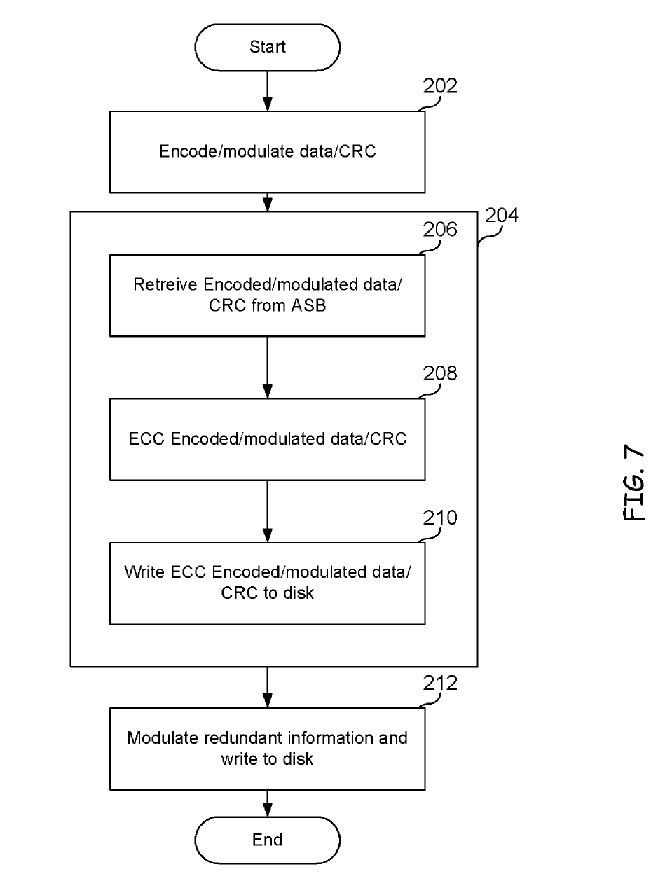

During a disk write operation, as illustrated by the logic flow diagram of FIG. 7, the data and redundant information is segregated and stored in the ASB in step 202. The segregated data and user information is used to generate data symbols in step 204. When a systematic code is applied to reduce DC content, such as an RDS or RLL code, the data symbols may be modulated using the systematic code (RDS1) in step 206. An ECC process may be applied to the data symbols generated previously in step 204 to generate ECC parity symbols. A second systematic code (RDS2) may be applied to reduce DC content of the ECC parity symbols in step 208. The modulated data symbols and ECC parity symbols may be written to the disk in step 210.

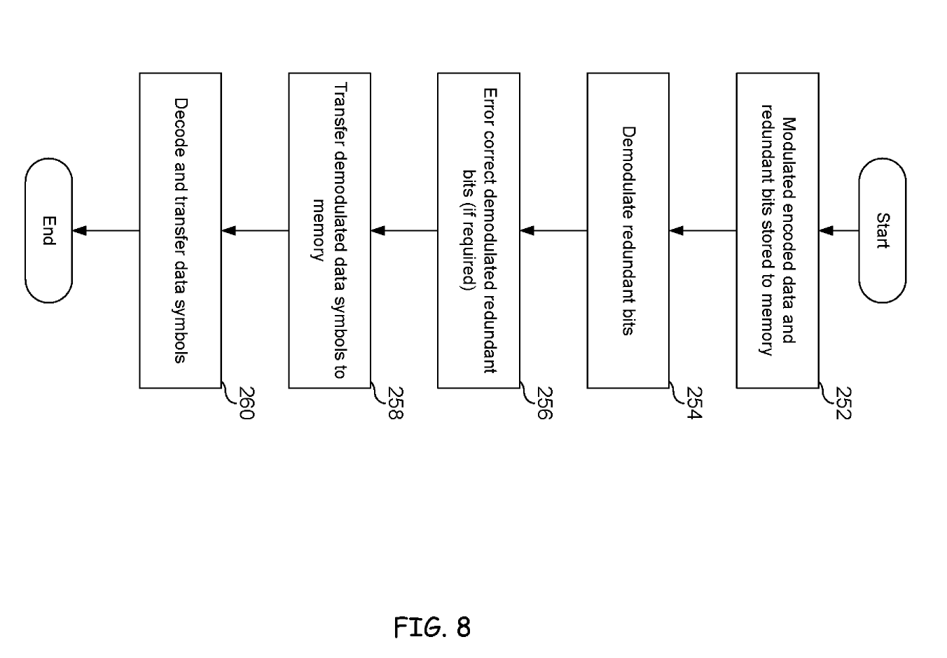

During a disk read operation, as illustrated by the logic flow diagram of FIG. 8, when RDS mode is enabled, the RDS1 encoded data symbols based on user data bits and redundant information bits, and RDS2 encoded ECC parity symbols are read from the storage media and stored in the appropriate ASB location in step 252. In step 254 the RDS1 encoded data symbols and RDS2 encoded ECC parity symbols are demodulated. ECC syndromes are computed based on the data symbols in step 256. The ECC syndromes and demodulated ECC parity symbols may be compared to determine the need for error correction. This error correction may then be performed as required. The demodulated (decoded) ECC symbols are clocked into the ECC symbol generator but not into the ASB. If an ECC correction is required in Step 256, the symbols are transferred to on the fly error correction (OTFEC) module and the correction is performed. At this time, the user data bits and redundant information bits are recovered from the data symbols and released to be transferred to the main buffer in step 258.

When the unity rate RLL Mode (provided for longitudinal recording) is enabled, the randomizer seed is first, loaded into the unity rate randomizer prior to the transfer of Buffer Manager data into the ABS. Then, during the transfer the randomizer generates a 48-bit random pattern based on four 12-bit Galois Field constant multiplications to generate the next four 12-bit pseudo random values, simultaneously. This 48-bit random value is XOR'd with the data CRC as it is passed through the RDS/RLL ENDEC on its way to the ASB.

Like the RDS redundant storage, the RLL randomizer seed is stored, in the ASB. The Disk Formatter section 164 of FIG. 5 contains an RLL checking circuit to cheek for RLL constraint violations during disk write operations.

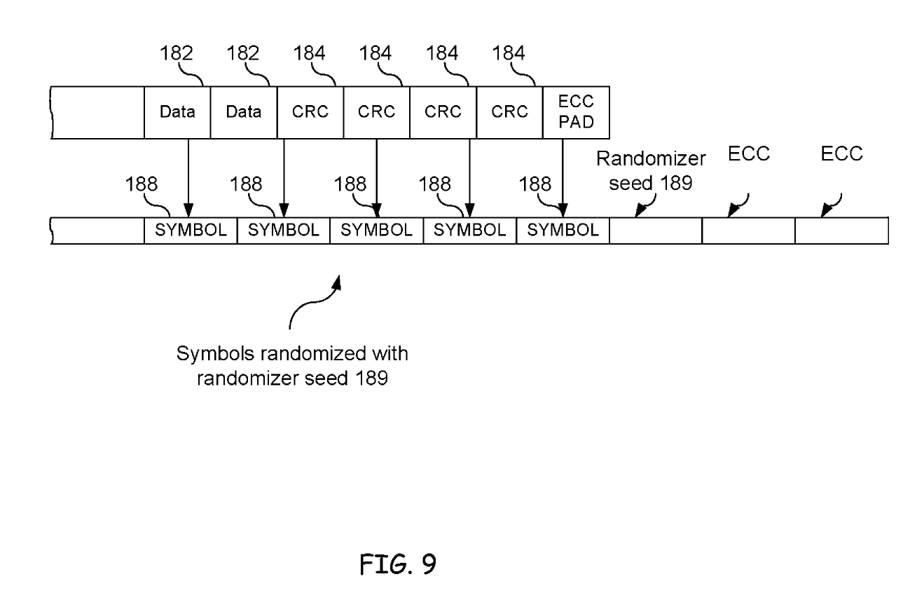

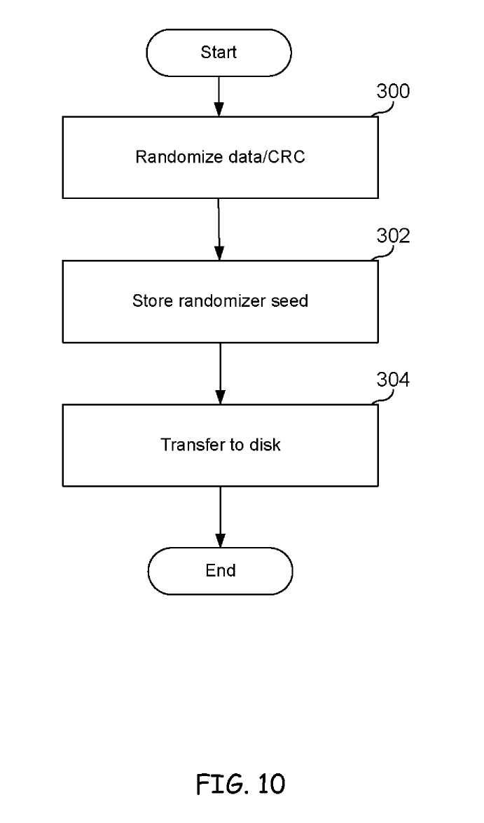

FIG. 9 depicts the integration of the RLL randomizer seed into the disk data stream. During a disk write operation such as the one presented in the logic flow diagram of FIG. 10, when RLL mode is enabled, the data/CRC is randomized in step 300. This randomization may be done 48-bits at a time as it is being stored in the ASB. The randomizer seed is stored in step 302, following the data as described above. Then during the transfer to disk of step 304, the encoded user data and the randomizer seed are retrieved from the ASB, ECC encoded and written to the disk. As seen previously in FIG. 6, the data initially includes user data 182, redundant (CRC) information 184 and ECC information. This information may be processed to produce data symbols 188 and ECC parity symbols. Symbols 188 may be randomized using randomizer seed 189. When the RLL mode is enabled the randomizer seed 184 may be stored following the data symbols. As shown in FIG. 9 and with reference to the logic flow diagram of FIG. 10, modulation control bits may be segregated in order to prevent error propagation within data that is written to and read from magnetic media.

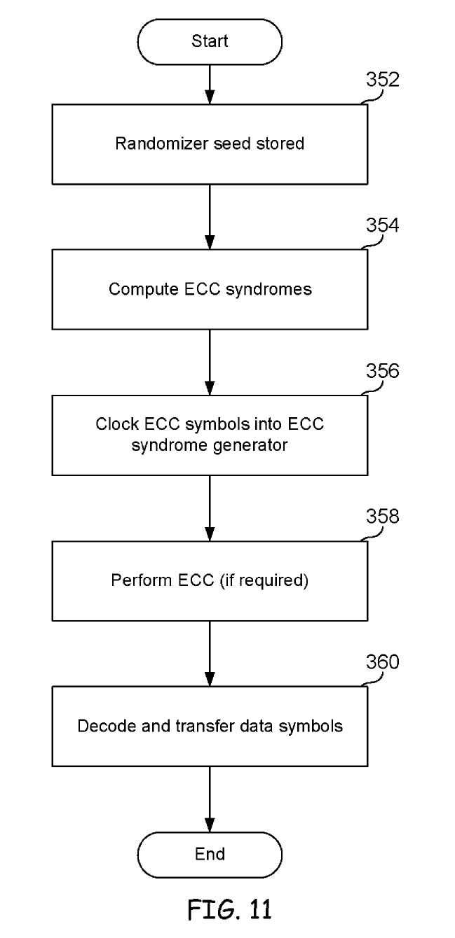

During a disk read operation such as that illustrated by the logic flow diagram of FIG. 11 when RLL mode is enabled, the randomized data/CRC (modulated data symbols) and randomizer seed are stored in the appropriate ASB location in step 350 while ECC syndromes are simultaneously computed in step 352. Immediately following the randomizer seed are the ECC parity symbols which are then clocked into the ECC syndrome generator in step 354 but not into the ASB. If an ECC correction is required, the syndromes are transferred to the OTFEC in step 354 and the correction is performed in the ABS. At this time, the corrected disk sector is released for transfer to the main buffer in step 356. At the start of the transfer to the buffer, the unity rate randomizer is initialized with the randomizer seed, pointed to by the same pointer mechanism as described for the disk write operation. Then the data is de-randomized by XORing the randomizer data pattern with the (already randomized) user data and transferred to the buffer manager.

Embodiments in the present invention provide a system and method of storing redundant information separately and contiguously with encoded user data such that all redundant information is co-located. Additionally, boundaries may be defined for how error correction coding is processed such that redundant information may be error corrected independently from encoded user data. By providing this ability, many controller related issues are addressed and the propagation of errors and the effects thereof may be reduced. More specifically, one embodiment provides a method to encode (modulate) data to be written to magnetic media. First, a bit stream that comprises data bits and redundant bits is received. This bit stream may be encoded to produce a plurality of symbols. This encoding may involve modulation such that the DC content of the plurality of symbols is limited. A first encoding process (modulating process) may be used to limit the DC content of the symbols. This modulation may also result in a first set of informational bits that describe the modulation process used to limit the DC content of the symbols. This first set of informational bits may also be modulated to limit the DC content of this set of informational bits. This results in a second set of informational bits that may be segregated from the plurality of the symbols. Additionally error correction of the information bits that describe the modulation process used to limit the DC content of the symbols and the first set of informational bits may be performed separately from that error correction performed on the user data and redundant information. This allows the informational bits that describe the modulation processes used to limit DC content to be corrected independently from the encoded user data.

Embodiments of the present invention also address the process wherein data may be decoded from magnetic media. This involves reading a first set of information bits contiguous to but segregated from a set of symbols. This set of informational bits may describe a modulation process used to limit the DC content of the set of symbols. Additionally error code correction may be performed on the set of informational bits separately from that performed on the set of user data bits symbols. This allows a processor to determine the demodulation process to be applied to the symbols which have been modulated in such a manner as to limit the DC content there in. By performing error correction coding on the set of informational bits separately from that performed on the symbols one can avoid or limit the propagation of errors which may result in an inaccurate description of the modulation process to be applied to the symbols. Symbols may then be demodulated using the set of informational bits to produce data bits and redundant bits which may have error correction coding algorithms applied to result in the proper decoding of the data bits.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions, and alterations can be made hereto without departing from the spirit and scope of the invention as described by the appended claims.

What is claimed is:

1. A method to encode data to a storage media, comprising:
receiving a data stream at a buffer, wherein the data stream comprises data bits and redundant bits;
segregating the data bits and redundant bits;
generating data symbols from the segregated data bits and redundant bits;
modulating the data symbols with a first systematic code to produce modulated data symbols wherein modulation reduces the DC content of the data symbols;
generating error correction code (ECC) parity symbols based on the data symbols wherein an ECC parity symbol is associated with either a user data symbol or a redundant information symbol;
modulating the ECC parity symbols with a second systematic code to produce modulated ECC parity symbols; and writing the modulated data symbols and the modulated ECC parity symbols to the storage media.

2. The method of claim 1, wherein r wherein the data symbols comprise user data symbols based only on the data bits and redundant information symbols based only on the redundant bits.

3. The method of claim 2, wherein ECC encoding is applied separately to the user data symbols based only on the data bits and the redundant information symbols based only on the redundant bits.

4. The method of claim 1, wherein the first and second systematic code comprises a run length limiting (RLL) and/or running digital sum (RDS) encoding process.

5. The method of claim 1, wherein the data is encoded by a disk drive controller.

6. The method of claim 1, wherein the disk drive controller is implemented as an integrated circuit.

7. A method to read data from storage media, comprising:
reading a data stream from the storage media wherein the data stream comprises modulated data symbols and modulated error correction code (ECC) parity symbols;
demodulating the modulated data symbols to produce data symbols, wherein the modulated data symbols were modulated with a first systematic code;
demodulating the modulated ECC parity symbols to produce ECC parity symbols, wherein the modulated ECC parity symbols were modulated with a second systematic code;
determining ECC syndromes based on the data symbols;
comparing the ECC syndromes and the ECC parity symbols to determine a need for ECC correction;
performing ECC correction when the ECC syndromes and the ECC parity symbols compare unfavorably; and
demodulating the data symbols to produce data bits and redundant bits, wherein the data symbols comprise user data symbols based only on the data bits and redundant information symbols based only on the redundant bits; and
decoding data from the data bits and redundant bits.

8. The method of claim 7, wherein the user data symbols based are segregated from the redundant information symbols.

9. The method of claim 7, further comprising reintegrating the data bits and redundant bits.

10. The method of claim 7, wherein the first and second systematic code comprise a run length limiting (RLL) and or running digital sum (RDS) encoding process.

11. The method of claim 7, wherein the data is demodulated by a disk drive controller.

12. The method of claim 7, wherein the disk drive controller is implemented as an integrated circuit.

13. A disk drive controller, comprising:
a first interface operable to read and/or write to a storage media;
a data path operable to encode/decode data first buffer;
a second interface operable to read and/or write to an external device; and
wherein the data path is operable to:
exchange a bit stream comprising data bits and redundant bits with the second interface;
segregate the data bits and redundant bits;
generate data symbols from the segregated data bits and redundant bits, wherein the data symbols comprise user data symbols based only on the data bits and redundant information symbols based only on the redundant bits;
modulate the data symbols with a first systematic code to produce modulated data symbols wherein modulation reduces the DC content of the data symbols;
generate error correction code (ECC) parity symbols based on the data symbols wherein an ECC parity symbol is associated with either a user data symbol or a redundant information symbol;
modulate the ECC parity symbols with a second systematic code to produce modulated ECC parity symbols; and
write the modulated data symbols and the modulated ECC parity symbols to the storage media via the first interface.

14. The disk drive controller of claim 13, wherein the data path is further operable to:
apply ECC encoding separately to the user data symbols based only on the data bits and the redundant information symbols based only on the redundant bits.

15. The disk drive controller of claim 13, wherein the first and second systematic code comprises a run length limiting (RLL) and/or running digital sum (RDS) encoding process.

16. The disk drive controller of claim 13, wherein the disk drive controller is implemented as an integrated circuit.

17. The disk drive controller of claim 13, wherein the data path further comprises:
an arbitrated sector buffer;
an RLL/RDS Encoder/Decoder (ENDEC); and
an error correction module.

18. A disk drive controller, comprising:
a first interface operable to read and/or write to a storage media;
a data path operable to encode/decode data first buffer;
a second interface operable to read and/or write to an external device; and
wherein the data path is operable to:
read a data stream from the storage media wherein the data stream comprises modulated data symbols and modulated error correction code (ECC) parity symbols;
demodulate the modulated data symbols to produce data symbols, wherein the modulated data symbols were modulated with a first systematic code;
demodulate the modulated ECC parity symbols to produce ECC parity symbols, wherein the modulated ECC parity symbols were modulated with a second systematic code;
determine ECC syndromes based on the data symbols;
compare the ECC syndromes and the ECC parity symbols to determine a need for ECC correction;
perform ECC correction when the ECC syndromes and the ECC parity symbols compare unfavorably;
demodulate the data symbols to produce data bits and redundant bits, wherein the data symbols comprise user data symbols based only on the data bits and redundant information symbols based only on the redundant bits; and
decode data from the data bits and redundant bits.

19. The disk drive controller of claim 18, wherein the data path is further operable to:
apply ECC encoding separately to the user data symbols based only on the data bits and the redundant information symbols based only on the redundant bits.

20. The disk drive controller of claim 18, wherein the first and second systematic code comprises a run length limiting (RLL) and/or running digital sum (RDS) encoding process.

21. The disk drive controller of claim 18, wherein the disk drive controller is implemented as an integrated circuit.

22. The disk drive controller of claim 18, wherein the data path further comprises:
an arbitrated sector buffer;
an RLL/RDS Encoder/Decoder (ENDEC); and
an error correction module.
